(19) United States
(12) Patent Application Publication
(10) Pub. No.: US 2006/0122057 A1
(43) Pub. Date: Jun. 8, 2006

(54) Preparation of nanometered gold catalyzer

(76) Inventor: Ming-Theng Wang, Chung Ho City (TW)

Correspondence Address: LEONG C LEI, PMB # 1008, 1867 YGNACIO VALLEY ROAD, WALNUT CREEK, CA, 94598, US

(21) Appl. No.: 11/002,180

(22) Filed: Dec. 3, 2004

(51) Int. Cl. B01J 23/52

(52) U.S. Cl. 502/344

(57) ABSTRACT

A nanometered gold catalytic coating material for use in gas mask, mouth-muffle, gasoline additive, filter for air cleaner and the like to eliminate the toxicity of carbon monoxide is disclosed to be prepared by: adding gold grains of diameter below 5 nm to an organic solution, and then adding O₂ to the solution, thereby causing gold grains to form Au₂O₂, and then adding porous metal carriers of diameter greater than 5 nm to Au₂O₂ solution, for enabling Au₂O₂ to be adhered to the pores in the metal carriers, and thus a nanometered gold catalyzer is thus obtained.

### BACKGROUND OF THE INVENTION

1. Field of the Invention

The present invention relates the preparation of a gold catalyzer and more particularly, to the preparation of a nanometered golf catalyzer, which is practical for use in any of a variety of products to eliminate the toxicity of carbon monoxide.

2. Description of the Related Art

Carbon monoxide (Co) is a fatal toxic gas. A man will lose the consciousness and die when put in a space where carbon monoxide concentration is 2000 ppm. If carbon monoxide concentration is increased to 5000 ppm, the man will die soon within a few minutes. Because carbon monoxide is colorless and gives no smell, it is difficult to find the existence of carbon monoxide. It is frequently reported every year that people were died due to breathing in a big amount of carbon monoxide that was produced from a fire or incomplete combustion of fuel gas in a water heater. Many people died in a fire catastrophe not by the flame but by carbon monoxide. In early days, a fireman usually uses a Hopcalite carbon monoxide filter can containing copper-manganese oxide when entering a place on fire to rescue people. However, this filter can is inconvenient for use in firefighting or helping people to escape from a fire because it is effective for about 30 minutes only and has a heavy weight (about one kilogram). Currently, a compressed-air cylinder or oxygen can is used to substitute for the aforesaid filter can. However, a compressed-air cylinder or oxygen can may be as heavy as 2.5 kgs, not convenient to carry.

It is frequently reported that people died from breathing in excessive amount of carbon monoxide that was produced due to incomplete combustion of fuel gas in a water heater.

Further, motorcars and motorcycles discharge a big amount of carbon monoxide to pollute the environment every day. There were people using exhaust gas from a car to commit suicide. Every fuel produces carbon monoxide when burned. If a gas burner is maintained in a good status and properly used, it does not produce a significant amount of carbon monoxide during burning. However, because carbon monoxide is a colorless gas that gives no smell, it is frequently heard that people were poisoned by carbon monoxide.

### SUMMARY OF THE INVENTION

The present invention has been accomplished under the circumstances in view. It is the main object of the present invention to a small size, light weight, low cost material, which is practical for use in any of a variety of products to eliminate carbon monoxide poisoning accidents and reduce air pollution due to exhaust gas from motor vehicles. The material of the present invention is developed subject to the properties of gold grains in a particular diameter.

Gold is a highly stable metal. It is not catalytic. However, gold grains made in a nanometer scale below 5 nm will lose the balance of atomic bonding, thereby producing a “room temperature active” status. Under a normal temperature range (ranging from −70˜250° C.), nanometered gold grains become active to oxidize carbon monoxide.

When used in a catalyzer, nanometered gold converts carbon monoxide into carbon dioxide. Therefore, nanometered gold catalyzer can be used in exhaust pipes to reduce pollution of exhaust gas to the environment. Comparing to the conventional technique of using platinum as catalyzer, the fine structure of nanometered gold catalyzer can be more tightly bonded to the exhaust pipes to effectively postpone aging of catalytic converter.

According to tests, gold grains having a diameter without about 2˜3 nm show the best stability of active property. Gold grains smaller than this diameter show no improvement in catalytic performance and will be bonded to one another to lose the active property. However, in order to enhance catalyzer's mass transfer control, carriers must be used to support gold grains. The carriers can be obtained from iron, cobalt, nickel, manganese, copper, or titanium. The carriers preferably have a size about 20 nm. By means of increasing the specific surface area and distribution of pores, the interaction between gold and the carriers is enhanced, thereby improving the whole reactive performance of the nanometered gold catalyzer.

The specific surface area of a conventional catalyzer is smaller than 50 m²/g. A nanometered gold catalyzer prepared according to the present invention has a specific surface area greater than 300 m²/g, and a big number of pores (1019) of diameter about 3˜4 nm that provides a high adhesive force to carbon monoxide.

When monoxide touches a nanometered gold catalyzer, an oxidation reaction will be produced, and the oxygen atoms of the nanometered gold catalyzer will be converted into carbon dioxide, and at the same time the nanometered gold catalyzer will receive supply of oxygen atoms from the air to make a cycle. Under an environment without oxygen, a nanometered gold catalyzer will adhere carbon monoxide and provides adhered carbon monoxide with its oxygen atoms. Because of the effect between nanometered gold grains and carriers, a nanometered gold catalyzer can adhere carbon monoxide about 10 times of the amount of gold (molar ratio normally at 1:1).

A nanometered gold catalyzer prepared according to the present invention can be used in a mouth-muffle and connectors for carbon monoxide protection. A mouth-muffle coated with a nanometered gold catalyzer has the advantages of light weight and long service life. The activeness of the catalyzer can be maintained more than 200 hours. Therefore, a mouth-muffle coated with a nanometered gold catalyzer is practical for use to help people escape from a fire or to help a fireman rescue people from a fire. Further, in comparison to conventional gas muffles, a mouth-muffle coated with a nanometered gold catalyzer is convenient in use.

Further, a fire prevention mask unit comprises a facemask, and a filter can (self-contained breathing apparatus) connectable to the facemask through a connector. If a connector for this purpose is coated with a nanometered gold catalyzer prepared according to the present invention, it adds an additional carbon monoxide prevention function to the fire prevention mask unit.

Further, incomplete combustion of fuel gas in a water heater will produce carbon monoxide that may kills people. A nanometered gold catalyzer prepared according to the present invention can also be used in a water heater or carbon monoxide alarm. For example, a meshed guard coated with a nanometered gold catalyzer prepared according to the present invention can be used in a water heater and covered over the exhaust hole to convert produced carbon monoxide into carbon dioxide. When converting carbon monoxide into carbon dioxide, a heat energy will be produced to trigger the alarm.

In addition to converting carbon monoxide into carbon dioxide, a nanometered gold catalyzer can also convert ozone and hydrogen for other applications. For example, ozone concentration is an index to air pollution. Excessive high concentration of ozone in air will do nut to human breathing system. A nanometered gold catalyzer can convert ozone into oxygen instantly, improving air quality. Further, the exhaust gas from a semiconductor foundry contains a big amount of hydrogen. A wire gauze filter coated with a nanometered gold catalyzer prepared according to the present invention can convert high concentration hydrogen into water that is not harmful to the environment. When used in a fuel battery, the invention converts carbon monoxide into carbon dioxide, preventing damage of carbon monoxide to electrodes and improving the performance of the battery.

A nanometered gold catalyzer can be used in many other products for different applications, providing a high industrial value.

The preparation of a nanometered gold catalyzer according to the present invention is based on the base material of gold salt, which is solved in a particular solution and then treated through a heat treatment or low temperature treatment to form gold grains having a diameter below 5 nm. The nanometered gold grains thus obtained are added to an organic solution, and then O₂ is added to the solution to form Au₂O₂, and then porous metal carriers of diameter greater than 5 nm are added to Au₂O₂ solution, for enabling Au₂O₂ to be adhered to the pores in the metal carriers, and thus a nanometered gold catalyzer is thus obtained. Further, the ratio by weight between said gold grains and said metal carriers in said organic solution is 1:5.

According to tests, one grain of the prepared nanometered gold catalyzer can oxidize 5 litters carbon monoxide of concentration 10000 oom within one minute. The service life of the prepared nanometered gold catalyzer is over 20 hours. When used in a saturated humility environment, the service life of the nanometered gold catalyzer is over 100 hours. When used in a mouth-muffle, the nanometered gold catalyzer can reduce carbon monoxide from the concentration of 2500 ppm at the inlet to the concentration of 5 ppm at the outlet, or from the concentration of 10000 ppm at the inlet to the concentration of 67 ppm at the outlet.

### BRIEF DESCRIPTION OF THE DRAWINGS

FIG. 1 is a schematic drawing showing the synthesis of a nanometered gold catalyzer according to the present invention.

### DETAILED DESCRIPTION OF THE INVENTION

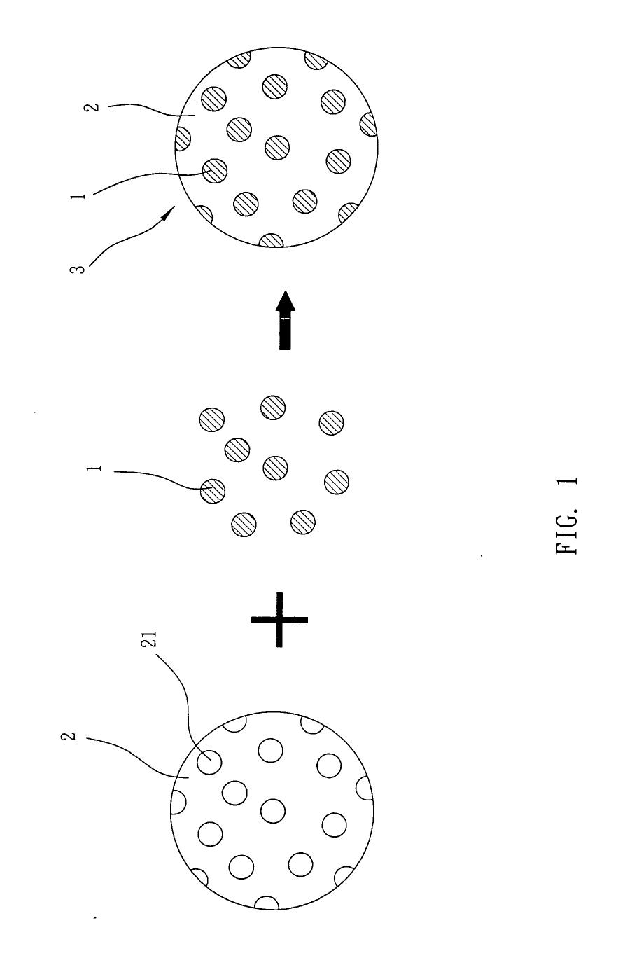

Referring to FIG. 1, a nanometered gold catalyzer is prepared by: adding gold grains of diameter below 5 nm to an organic solution, and then adding O₂ to the solution, thereby causing gold grains to form Au₂O₂, and then adding porous metal carriers of diameter greater than 5 nm to Au₂O₂ solution, for enabling Au₂O₂ to be adhered to the pores in the metal carriers, and thus a nanometered gold catalyzer is thus obtained. Further, the ratio by weight between said gold grains and said metal carriers in said organic solution is 1:5. The aforesaid metal carriers can be obtained from lead, zinc, aluminum, iron, copper, titanium, or cobalt, having a size about 20 nm. As illustrated in FIG. 1, the metal carrier 2 has pores 21. Au₂O₂ grains 1 filled up the pores 21, thereby forming a gold catalyzer 3.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A nanometered gold catalyzer preparation method comprising the steps of:
(a) adding gold grains of diameter below 5 nm to an organic solution;
(b) adding O₂ to said organic solution to form an Au₂O₂ solution;
(c) adding porous metal carriers of diameter greater than 5 nm to said Au₂O₂ solution, for enabling Au₂O₂ to be adhered to the pores of said porous metal carriers to form with said porous metal carriers the desired nanometered gold catalyzer.

2. The nanometered gold catalyzer preparation method as claimed in claim 1, wherein said porous metal carriers have a diameter about 20 nm.

3. The nanometered gold catalyzer preparation method as claimed in claim 2, wherein the ratio by weight between said gold grains and said metal carriers in said organic solution is 1:5.

4. The nanometered gold catalyzer preparation method as claimed in claim 3, wherein said metal carriers are obtained from lead.

5. The nanometered gold catalyzer preparation method as claimed in claim 3, wherein said metal carriers are obtained from zinc.

6. The nanometered gold catalyzer preparation method as claimed in claim 3, wherein said metal carriers are obtained from aluminum.

7. The nanometered gold catalyzer preparation method as claimed in claim 3, wherein said metal carriers are obtained from iron.

8. The nanometered gold catalyzer preparation method as claimed in claim 3, wherein said metal carriers are obtained from copper.

9. The nanometered gold catalyzer preparation method as claimed in claim 3, wherein said metal carriers are obtained from titanium.

10. The nanometered gold catalyzer preparation method as claimed in claim 3, wherein said metal carriers are obtained from cobalt.
